(19) United States
(12) Patent Application Publication
(10) Pub. No.: US 2004/0059904 A1
(43) Pub. Date: Mar. 25, 2004

(54) Program-controlled unit

(76) Inventor: Steffen Sonnekalb, Munchen (DE)

Correspondence Address: LERNER AND GREENBERG, P.A., Post Office Box 2480, Hollywood, FL, 33022-2480, US

(21) Appl. No.: 10/667,720

(22) Filed: Sep. 22, 2003

Related U.S. Application Data
(63) Continuation of application No. PCT/EP01/03282, filed on Mar. 22, 2001.

(51) Int. Cl. G06F 15/177

(52) U.S. Cl. 713/1

(57) ABSTRACT

The invention describes a program-controlled unit having an instruction execution pipeline including a plurality of pipeline stages. The program-controlled unit can execute instructions that instruct it to stop individual pipeline stages, a plurality of pipeline stages or all of the pipeline stages. This allows the stopping of the pipeline stages to be tested simply, quickly and comprehensively under all circumstances.

### CROSS-REFERENCE TO RELATED APPLICATION

This application is a continuation of copending International Application No. PCT/EP01/03282, filed Mar. 22, 2001, which designated the United States and was published in English.

### BACKGROUND OF THE INVENTION

### FIELD OF THE INVENTION

The present invention relates to a program-controlled unit having an instruction execution pipeline including a plurality of pipeline stages.

Program-controlled units are microprocessors, microcontrollers, signal processors, and the like.

In program-controlled units having an instruction execution pipeline, instructions that are to be executed are processed in a plurality of successive substeps. Various substeps can be executed at the same time for various instructions. This means that, while the nth substep is being executed for an xth instruction, at the same time the (n−1)th substep is being executed for an (x+1)th instruction that is to be carried out thereafter, and the (n−2)th substep is being executed for an (x+2)th instruction that is to be carried out thereafter, etc. The number of substeps in which the instructions are executed varies in practice and can, in principle, be stipulated as desired.

The various substeps are executed in various pipeline stages.

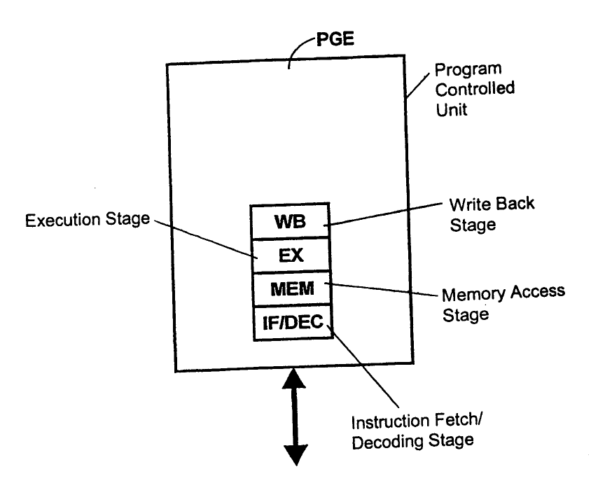

The figure shows a program-controlled unit containing a four-stage pipeline. For the sake of completeness, it should be pointed out that FIG. 1 shows only those component parts of the program-controlled unit that are of particular interest in the present case.

The four pipeline stages of the program-controlled unit PGE shown in the figure are an IF/DEC (instruction fetch/decoding) stage, a MEM (memory access) stage, an EX (execution) stage and a WB (write back) stage. In the IF/DEC stage, an instruction which is to be executed is read from a program memory provided inside or outside the program-controlled unit and is decoded. In the MEM stage, any data memory access operations which may be necessary are executed, for example, in order to fetch operands required for instruction execution. In the EX stage, the actual instruction execution takes place. In the WB stage, results generated in the EX stage are written to a memory.

The individual pipeline stages are designed such that the respective operations that the stages need to execute are executed within the same time, for example, within one clock period, and the instructions are then processed further in the respectively next pipeline stage.

However, it may arise that a pipeline stage requires more time to carry out the operation., which it needs to execute, than is normally the case.

By way of example, the MEM stage requires more time than normal to execute the operation, which it needs to execute, if the memory which it is accessing is a particularly slow memory, or if another component of the program-controlled unit, for example, the WB stage, is at the same time also accessing the memory that the MEM stage needs to access.

In this case, the program-controlled unit stops individual pipeline stages, a plurality of the pipeline stages, or all other pipeline stages until the pipeline stage that requires more time has executed the operation that it needs to execute.

If, by way of example, the MEM stage requires more time than usual for the operation that it needs to carry out, then at least the pipeline stages provided upstream thereof, that is to say the IF/DEC stage, need to be stopped temporarily, because the data and signals that are supplied to the MEM stage from the IF/DEC stage before the operation currently being executed has ended are left out of consideration and/or disrupt execution of the operation currently being executed, and/or because data provided by the IF/DEC stage for the MEM stage to fetch may be overwritten before they are fetched. The pipeline stages provided downstream of the MEM stage, that is to say the EX stage and/or the WB stage, need not generally be stopped. Under certain circumstances, these pipeline stages may also need to be stopped, however. This may be the case, for example, if, for whatever reason, the execution of particular instructions or instruction sequences must not be interrupted, or if operands which are to be fetched by the MEM stage need to be fetched before they are overwritten by a preceding instruction.

It should be clear and requires no more detailed explanation that there is also a whole series of other conditions under which one, a plurality of or all pipeline stages need to be stopped.

To be able to ensure correct operation of the program-controlled unit under all circumstances, it must be possible for all of the pipeline stages to be stopped independently of one another for any desired length of time, and for the pipeline stages to be stopped such that—apart from the time required for program execution—the program which is currently being executed is executed in exactly the same way as if no pipeline stages were stopped.

Since correct stopping of the pipeline stages is of very great importance for the correct operation of the program-controlled unit, extensive tests need to be carried out to determine whether the pipeline stages are stopped correctly.

However, such a test is associated with an enormous amount of effort. This is because conditions under which the individual pipeline stages are stopped can be created only with great difficulty.

### SUMMARY OF THE INVENTION

It is accordingly an object of the invention to provide a configuration including a program-controlled unit, which overcomes the above-mentioned disadvantages of the prior art apparatus of this general type.

In particular, it is an object of the invention to provide a configuration including a program-controlled unit enabling a simple, quick and comprehensive test to determine whether the program-controlled unit stops an individual pipeline stage, a plurality of pipeline stages, or all of the pipeline stages correctly.

With the foregoing and other objects in view there is provided, in accordance with the invention, a configuration including a program-controlled unit with an instruction execution pipeline having a plurality of pipeline stages. The program-controlled unit is configured for executing instructions instructing the program-controlled unit to stop an individual one of the plurality of pipeline stages, more than one of the plurality of pipeline stages, or all of the plurality of pipeline stages. The instructions stipulate which particular one of the plurality of pipeline stages or which particular ones of the plurality of pipeline stages should be stopped.

The program-controlled unit is distinguished in that it is able to execute instructions that instruct it to stop an individual pipeline stage, a plurality of pipeline stages, or all of the pipeline stages.

This eliminates the need to have to create conditions for which one pipeline stage, a plurality of pipeline stages, or all pipeline stages are stopped. It is a simple matter to give an instruction to stop the pipeline stages as required, which allows the stopping of the pipeline stages to be tested simply, quickly and comprehensively under all circumstances.

Other features which are considered as characteristic for the invention are set forth in the appended claims.

Although the invention is illustrated and described herein as embodied in a program-controlled unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The sole drawing figure shows a configuration of a program-controlled unit.

### DESCRIPTION OF THE PREFERRED EMBODIMENTS

The program-controlled unit described below has the same design as the program-controlled unit PGE described in the introduction with reference to the drawing figure. That is to say, it is a program-controlled unit having an instruction processing pipeline including a plurality of pipeline stages, with individual pipeline stages, a plurality of pipeline stages, or all of the pipeline stages being able to be stopped upon the occurrence of particular states or events. The stopping conditions can possibly be the stopping conditions mentioned in the introduction or they can be any other stopping conditions.

The program-controlled unit is distinguished in that it is able to execute instructions that instruct it to stop individual pipeline stages, a plurality of pipeline stages, or all of the pipeline stages. These instructions are called pipeline instructions below.

The pipeline instructions at least stipulate which pipeline stage or which pipeline stages need to be stopped in each case.

Preferably, the pipeline instructions can also stipulate the length of time, for example, how many clock periods, that the pipeline stage intended to be stopped will be stopped. This can be done by an appropriate operand in the instruction or instructions with various opcodes.

Preferably, the pipeline instructions are also able to stipulate the time at which, for example, how many clock periods after execution of the instruction, the pipeline stage intended to be stopped will be stopped. This can also be done by an appropriate operand in the instruction or instructions with various opcodes.

Provision of the two latter stipulations is found to be very advantageous, but it is not absolutely necessary. Even without these stipulations, the pipeline instructions permit the stopping of individual pipeline stages, a plurality of pipeline stages, or all of the pipeline stages to be tested quickly, simply and comprehensively.

The stipulation of the beginning of stopping and/or of the duration of stopping can naturally also be set in any desired other way, for example, using other instructions as the pipeline instructions, or using a test device connected to the program-controlled unit, or an emulator.

Provision could also be made for the beginning of stopping and/or for the duration of stopping to be set permanently (such that it cannot be varied).

Irrespective of whether and possibly how the beginning of stopping is set, it is generally found to be advantageous if stopping of the respective pipeline stage to be stopped is not begun until after the instruction that instructs the stopping has passed through the pipeline. This makes it possible to prevent pipeline instructions from corrupting the test result.

The pipeline instructions can, but do not have to, be executed in the EX stage. The pipeline instructions can also be executed in any other pipeline stage.

Provision of the pipeline instructions eliminates the need to create conditions that result in individual or a plurality of pipeline stages being stopped. The program-controlled unit can thus be prompted, at any time and without any significant effort, to stop individual pipeline stages, a plurality of pipeline stages or all of the pipeline stages at a desired instant for a desired time.

Preferably, execution of the pipeline instructions is enabled only at particular times.

By way of example, provision may be made for execution of these instructions to be possible only during the first startup, which is carried out to test and initialize the program-controlled unit, and for the program-controlled unit to treat the pipeline instructions as unknown instructions thereafter.

Alternatively, provision could be made for it to be possible or necessary to enable execution of the pipeline instructions using a test apparatus for testing the program-controlled unit, or by using an emulator.

Irrespective of the manner of enabling or blocking execution of the pipeline instructions, it should be ensured that these pipeline instructions cannot be executed (treated as unknown instructions) during normal operation of the program-controlled unit.

This makes it possible to prevent errors in the program or in the program memory from stopping the processor. This is of greatest importance, in particular, but not exclusively, in safety-relevant applications, such as in an airbag control system.

I claim:

1. A configuration, comprising:
a program-controlled unit including an instruction execution pipeline having a plurality of pipeline stages;
said program-controlled unit configured for executing instructions instructing said program-controlled unit to stop an individual one of said plurality of pipeline stages, more than one of said plurality of pipeline stages, or all of said plurality of pipeline stages; and
the instructions stipulating which particular one of said plurality of pipeline stages or which particular ones of said plurality of pipeline stages should be stopped.

2. The configuration according to claim 1, wherein said program-controlled unit is configured for specifying a length of time for which a respective one of said plurality of pipeline stages is to be stopped.

3. The configuration according to claim 1, wherein the instructions, which instruct stopping, or other instructions can stipulate a length of time for which a respective one of said plurality of pipeline stages is to be stopped.

4. The configuration according to claim 1, wherein said program-controlled unit is configured for beginning to stop a respective one of said plurality of pipeline stages at a particular time after executing an instruction that instructs stopping.

5. The configuration according to claim 1, wherein said program-controlled unit is configured for beginning to stop a respective one of said plurality of pipeline stages after an instruction that instructs stopping has passed through said instruction execution pipeline.

6. The configuration according to claim 1, wherein said program-controlled unit is configured for setting a time at which a respective one of said plurality of pipeline stages will begin to be stopped.

7. The configuration according to claim 1, wherein the instructions, which instruct stopping, or other instructions can stipulate a time for beginning to stop a respective one of said plurality of pipeline stages.

8. The configuration according to claim 1, wherein said program-controlled unit is configured for blocking execution of the instructions, which instruct stopping.

9. The configuration according to claim 8, wherein said program-controlled unit is configured for treating the instructions, which instruct stopping, as unknown instructions when execution of the instructions, which instruct stopping, is not enabled.
